(19) United States
(12) Patent Application Publication
(10) Pub. No.: US 2010/0158305 A1
(43) Pub. Date: Jun. 24, 2010

(54) LOUDSPEAKER

(76) Inventors: Osamu Funahashi, Mie (JP); Hiroyuki Morimoto, Mie (JP); Kazuyoshi Umemura, Mie (JP)

Correspondence Address: RATNERPRESTIA, P.O. BOX 980, VALLEY FORGE, PA, 19482, US

(21) Appl. No.: 12/304,624

(22) PCT Filed: Jun. 5, 2008
(86) PCT No.: PCT/JP2008/001431

§ 371 Date: Dec. 12, 2008

(51) Int. Cl. H04R 1/00

(52) U.S. Cl. 381/397

(57) ABSTRACT

A loudspeaker includes frame, diaphragm whose outer rim is supported by this frame, voice coil unit connected to this diaphragm, magnetic circuit where voice coil of this voice coil unit is movably disposed in its magnetic gap, and first edge member and second edge member for supporting voice coil unit by frame. Voice coil unit is supported at two points at a predetermined interval to the side of magnetic gap from a part where diaphragm is connected. First edge member and second edge member include heat-resistant connectors that allow air to pass through, and ring edges and made of a resilient material connected to these connectors. Edge of first edge member or edge of second edge member protrudes toward diaphragm and the other edge protrudes toward magnetic circuit.

### TECHNICAL FIELD

The present invention relates to loudspeakers.

### BACKGROUND ART

In a conventional loudspeaker, as shown in FIG. 8, voice coil unit 2A, movably disposed on magnetic circuit 1A, is connected to the inner rim of diaphragm 3A, and the outer rim of diaphragm 3A is connected to frame 5A via edge 4A. In addition, the rear face of this diaphragm 3A is connected to frame 5A via suspension holder 6A and edge 7E.

Distortion of the loudspeaker is reduced by making protrusions from edges 4A and 7E in opposite directions such that the vertical excursion of diaphragm 3A becomes vertically symmetrical.

One of the typical prior arts related to the present invention is disclosed in Patent Document 1.

The loudspeaker shown in FIG. 8 employs suspension holder 6A for firmly supporting diaphragm 3A, which makes it heavy, although this type of loudspeaker shows few problems if it is used for woofers, to which significant power is applied. However, the driving efficiency falls due to its heavy weight if applied to mid-range loudspeakers or tweeters.

Patent Document 1: Japanese Patent Unexamined Publication No. 2004-7332.

### SUMMARY OF THE INVENTION

The present invention further improves a driving efficiency of low-distortion loudspeakers.

The present invention includes a frame, a diaphragm whose outer rim is supported by this frame via an edge, a voice coil unit connected to this diaphragm, a magnetic circuit where a voice coil of this voice coil unit is movably disposed in its magnetic gap, and first and second edge members for supporting the voice coil unit by the frame at two points with a predetermined interval to the side of a magnetic gap from a part where diaphragm is connected. The first and second edge members include heat-resistant connectors that allow air to pass through, and ring edges made of resilient material and are connected to these connectors. The edge of the first or the second edge members protrudes toward the diaphragm, and the other edge protrudes toward the magnetic circuit.

This structure suppresses distortion of the loudspeaker, and also improves the driving efficiency by reducing the weight of an excursion portion connected to the voice coil. Accordingly, this loudspeaker is applicable to mid-range loudspeakers and tweeters.

### BRIEF DESCRIPTION OF DRAWINGS

FIG. 1 is a sectional view of a loudspeaker in accordance with a first exemplary embodiment of the present invention.

FIG. 2 is a sectional view of a loudspeaker in accordance with a second exemplary embodiment of the present invention.

FIG. 3 is a perspective view of a key part of the loudspeaker in accordance with the second exemplary embodiment of the present invention.

FIG. 4 is a plan view of a key part of the loudspeaker in accordance with the second exemplary embodiment of the present invention.

FIG. 5 is a left side view of a key part of the loudspeaker in accordance with the second exemplary embodiment of the present invention.

FIG. 6 is a front view of a key part of the loudspeaker in accordance with the second exemplary embodiment of the present invention.

FIG. 7 is a rear view of a key part of the loudspeaker in accordance with the second exemplary embodiment of the present invention.

FIG. 8 is a sectional view of a conventional loudspeaker.

REFERENCE MARKS IN THE DRAWINGS

1 Magnetic circuit

2 Voice coil unit

2b Voice coil

3 Diaphragm

4 Edge

5 Frame

7A, 7B, 7 Edge member

7a, 7b, 7p Ring connector

7c, 7d, 7q Ring edge

8 Magnetic gap

### DETAILED DESCRIPTION OF PREFERRED EMBODIMENTS

### First Exemplary Embodiment

A loudspeaker in the first exemplary embodiment of the present invention is described below.

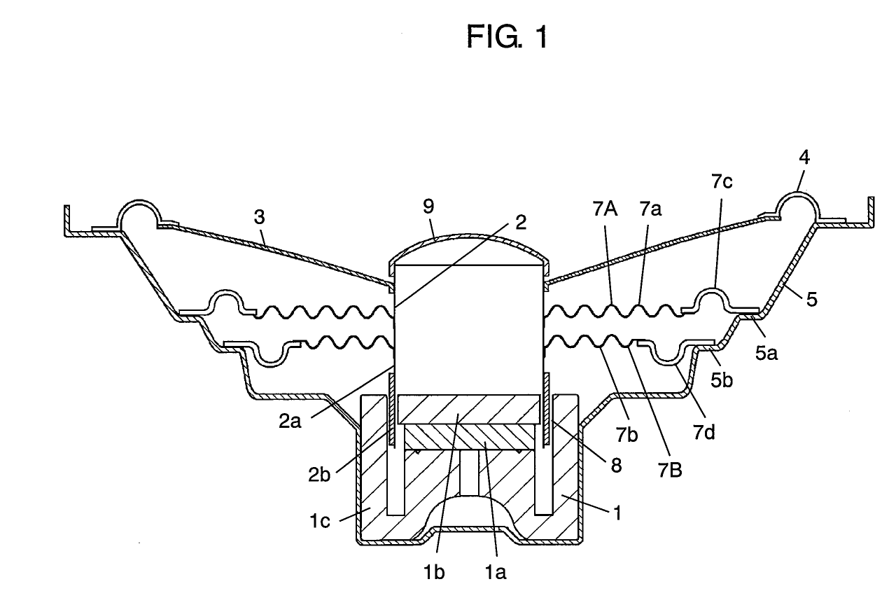

FIG. 1 is a sectional view of the loudspeaker in the first exemplary embodiment of the present invention. In FIG. 1, magnetic circuit 1, disposed on the bottom center of cone-shaped frame 5, is configured by assembling and bonding round magnet 1a, round plate 1b, and cylindrical yoke 1c. Cylindrical magnetic gap 8 is present between the inner side face of the side wall of yoke 1c and the outer side face of plate 1b. This magnetic gap 8 has an opening toward the upper face of magnetic circuit 1.

Voice coil unit 2 is configured such that voice coil 2b is wound around the outer rim of cylindrical body 2a. This voice coil 2b is disposed in a vertically movable manner relative to magnetic gap 8. This allows excursion of thin disc-like diaphragm 3 connected to the upper outer rim of cylindrical body 2a of voice coil unit 2. Dust cap 9 is provided on a top part of cylindrical body 2a of voice coil unit 2 as a dust-proofing measure.

Diaphragm 3 is the sound-generating source in the loudspeaker, and is thus mainly made of pulp and resin so as to achieve both high hardness and internal loss. The outer rim of this diaphragm 3 is connected to an open end of frame 5 via edge 4 protruding upward. The inner rim of diaphragm 3 is connected and fixed to the outer rim of body 2a of voice coil unit 2. Edge 4 is typically made of urethane, foamed rubber, SBR rubber, or cloth such that edge 4 does not apply load to the movement of diaphragm 3.

Edge members 7A and 7B are combined parts of ring connectors 7a and 7b, and ring edges 7c and 7d. Inner rims of ring connectors 7a and 7b of edge members 7A and 7B are connected to the outer rim of body 2a of voice coil 2, at a predetermined interval, at points to the side of magnetic circuit 1 from a part where diaphragm 3 is fixed. Outer rims of edge members 7A and 7B are connected to frame 5 via ring edges 7c and 7d at a predetermined interval. These ring connectors 7a and 7b are made by hardening a material such as cloth in a corrugated ring structure. If the movement distance of voice coil unit 2 is small, these ring connectors 7a and 7b stretch and compress in accordance with the vertical movement of voice coil unit 2. If the vertical movement distance of voice coil unit 2 is large, ring edges 7c and 7d follow the vertical movement, which is described later.

These ring connectors 7a and 7b are, as described above, made of a material such as cloth hardened in a corrugated ring structure, and a vent (not illustrated) is provided. Accordingly, ring connectors 7a and 7b allow air to pass through, and thus they apply less load to upward and downward movement of edge members 7A and 7B. In addition, since these ring connectors 7a and 7b are made of a material such as cloth hardened in a corrugated structure, as described above, they are heat-resistant. Accordingly, these ring connectors 7a and 7b and also ring edges 7c and 7d, to which ring connectors 7a and 7b are connected, do not deteriorate as a result of the heat generated from voice coil 2b of voice coil unit 2.

If an audio signal is applied to voice coil 2b of voice coil unit 2 in this structure, voice coil unit 2 moves up and down by reacting with the magnetic field in magnetic gap 8. This movement vibrates diaphragm 3, generating sound from the loudspeaker. In particular, distortion of the loudspeaker is suppressed and the driving efficiency of the loudspeaker is further improved by providing ring edges 7c and 7d on the outer rims of ring connectors 7a and 7b in edge members 7A and 7B. The reason is given below.

Conventionally, inner and outer ends of ring edges 7c and 7d are connected to frame 5 and voice coil unit 2, respectively, so as to suppress the rolling of voice coil unit 2 which may occur during its movement. In the loudspeaker in the first exemplary embodiment, this ring edge 7c protrudes toward diaphragm 3, ring edge 7d protrudes toward magnetic circuit 1, and both ring edges 7c and 7d are resilient so as to allow easy tracing of the movement of voice coil unit 2. By applying the audio signal to voice coil 2b of voice coil body 2, voice coil body 2 reacts with the magnetic field in magnetic gap 8, and moves upward and downward. If the excursion of voice coil unit 2 is small, above-mentioned ring connectors 7a and 7b do not impose a large load on the movement of voice coil unit 2. However, as the excursion of voice coil unit 2 becomes larger, ring connectors 7a and 7b hinder smooth vertical movement.

In the loudspeaker in the first exemplary embodiment of the present invention, the outer rims of ring connectors 7a and 7b are connected to frame 5 via ring edges 7c and 7d, respectively. When the excursion of voice coil unit 2 becomes large and ring connectors 7a and 7b start to apply load, stress is applied to ring edges 7c and 7d. Ring edges 7c and 7d then resiliently deform in response to this stress. Accordingly, although the excursion of voice coil unit 2 rises, the presence of ring edges 7c and 7d prevents hindering of the excursion, and thus reduction of driving efficiency is suppressed.

In the first exemplary embodiment, voice coil unit 2 is vertically supported by two supports: edge 4 and edge members 7A and 7B (combined parts of assembly of ring connectors 7a and 7b and ring edges 7c and 7d). To improve the driving efficiency of diaphragm 3, edge 4 is thinned so that its weight becomes lighter. This makes the weight of diaphragm 3 and edge 4 lighter, providing a structure that improves the driving efficiency of diaphragm 3. However, if edge 4 is thinned, the strength to support voice coil unit 2 is reduced. Therefore, ring edges 7c and 7d of edge members 7A and 7B are made thicker than edge 4 so as to prevent degradation in the strength to support voice coil unit 2. As a result, Young's modulus of edge members 7A and 7B (combined parts of ring connectors 7a and 7b, and ring edges 7c and 7d) becomes greater (harder) than that of edge 4.

In the above structure, edge members 7A and 7B (combined parts of ring connectors 7a and 7b and ring edges 7c and 7d) dominantly support voice coil unit 2. Accordingly, the upper load and lower load of edge members 7A and 7B (combined parts of assembly of ring connectors 7a and 7b and ring edges 7c and 7d) need to be kept at the same level as much as possible to suppress distortion in the vertical movement of the diaphragm. Since ring connectors 7a and 7b vibrate only slightly, as described above, the upper load and lower load of ring edges 7c and 7d are kept as much as possible at the same level in the first exemplary embodiment. For this purpose, ring edge 7c protrudes toward diaphragm 3 and ring edge 7d protrudes toward magnetic circuit 1. In addition, both ring edges 7c and 7d are resilient. The upper and lower loads are kept as much as possible at the same level by establishing a symmetric shape in the protruding directions of ring edges 7c and 7d relative to their boundary. Ring edges 7c and 7d are connected to steps 5a and 5b on frame 5, respectively. This achieves a reliable connection. A significant characteristic of the loudspeaker in the first exemplary embodiment of the present invention is that upper and lower loads of edge members 7A and 7B (combined parts of assembly of ring connectors 7a and 7b and ring edges 7c and 7d) that practically support voice coil unit 2 are kept at the same level.

This characteristic achieves symmetric vertical excursion of diaphragm 3, reducing distortion of the loudspeaker. In addition, edge 4, which has a large area on the outer rim of diaphragm 3, is thinned to make it lighter. This achieves high driving efficiency, even in mid-range loudspeakers and tweeters.

### Second Exemplary Embodiment

A loudspeaker in the second exemplary embodiment of the present invention is described below.

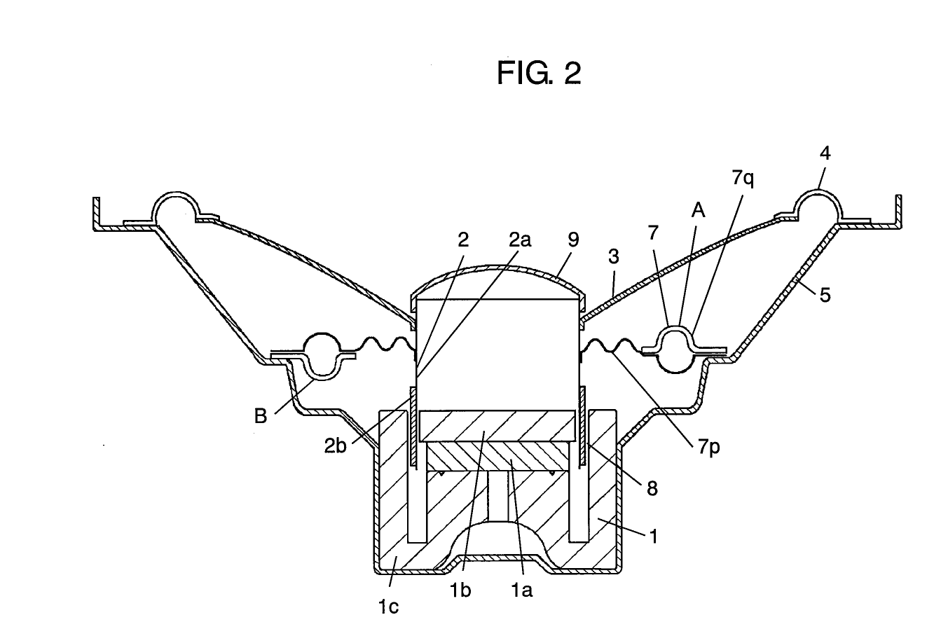

FIG. 2 is a sectional view of the loudspeaker in the second exemplary embodiment of the present invention. In FIG. 2, magnetic circuit 1, disposed on the bottom center of cone-shaped frame 5, is configured by assembling and bonding round magnet 1a, round plate 1b, and cylindrical yoke 1c. Cylindrical magnetic gap 8 is present between the inner side face of the side wall of yoke 1c and the outer side face of plate 1b. This magnetic gap 8 has opening toward the upper face of magnetic circuit 1.

Voice coil unit 2 is configured such that voice coil 2b is wound around the outer rim of cylindrical body 2a. This voice coil 2b is disposed in a vertically movable manner relative to magnetic gap 8. This allows excursion of thin disc-like diaphragm 3 connected to the upper outer rim of cylindrical body 2a of voice coil unit 2. Dust cap 9 is provided on a top part of cylindrical body 2a of voice coil unit 2 as a dust-proofing measure.

Diaphragm 3 is the sound-generating source in the loudspeaker, and is thus mainly made of pulp and resin so as to achieve both high hardness and internal loss. The outer rim of this diaphragm 3 is connected to an open end of frame 5 via edge 4 protruding upward. The inner rim of diaphragm 3 is connected and fixed to the outer rim of body 2a of voice coil unit 2. Edge 4 is typically made of urethane, foamed rubber, SBR rubber, or cloth such that edge 4 does not apply load to the movement of diaphragm 3.

An inner rim of ring connector 7p of edge member 7 is connected to the outer rim of body 2a of voice coil unit 2 at a point to the side of magnetic circuit 1 from a part where diaphragm 3 is fixed. An outer rim of ring connector 7p is connected to frame 5 via ring edge 7q. This ring connector 7p is made by hardening a material such as cloth in a corrugated ring structure. If the movement distance of voice coil unit 2 is small, this ring connector 7p stretches and compresses in accordance with the vertical movement of voice coil unit 2. If the vertical movement distance of voice coil unit 2 is large, ring edge 7q follows the vertical movement, which is described later.

This ring connector 7p, as described above, is made of a material such as cloth hardened in a corrugated ring structure and a vent (not illustrated) is provided. Accordingly, ring connector 7p allows air to pass through, and thus it applies less load to upward and downward movement of edge member 7. In addition, since this ring connector 7p is made of a material such as cloth hardened in a corrugated ring structure, as described above, it is heat-resistant. Accordingly, this ring connector 7p and also ring edge 7q, to which ring connector 7p is connected, do not deteriorate as a result of the heat generated from voice coil 2b of voice coil unit 2.

If an audio signal is applied to voice coil 2b of voice coil unit 2 in this structure, voice coil unit 2 moves up and down by reacting with the magnetic field in magnetic gap 8. This movement vibrates diaphragm 3, generating sound from the loudspeaker. In particular, distortion of the loudspeaker is suppressed and the driving efficiency of the loudspeaker is further improved by providing ring edge 7q on the outer rim of ring connector 7p in edge member 7. The reason is described below.

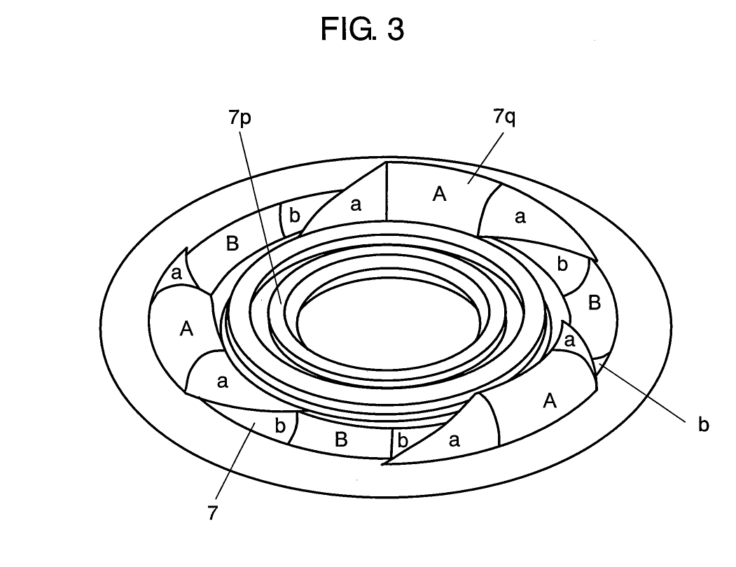

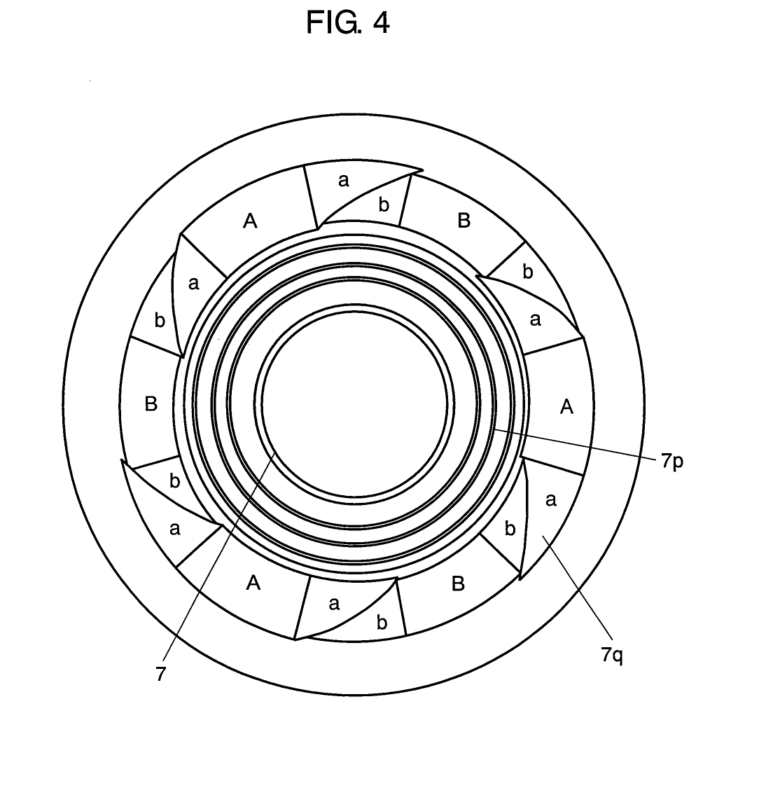

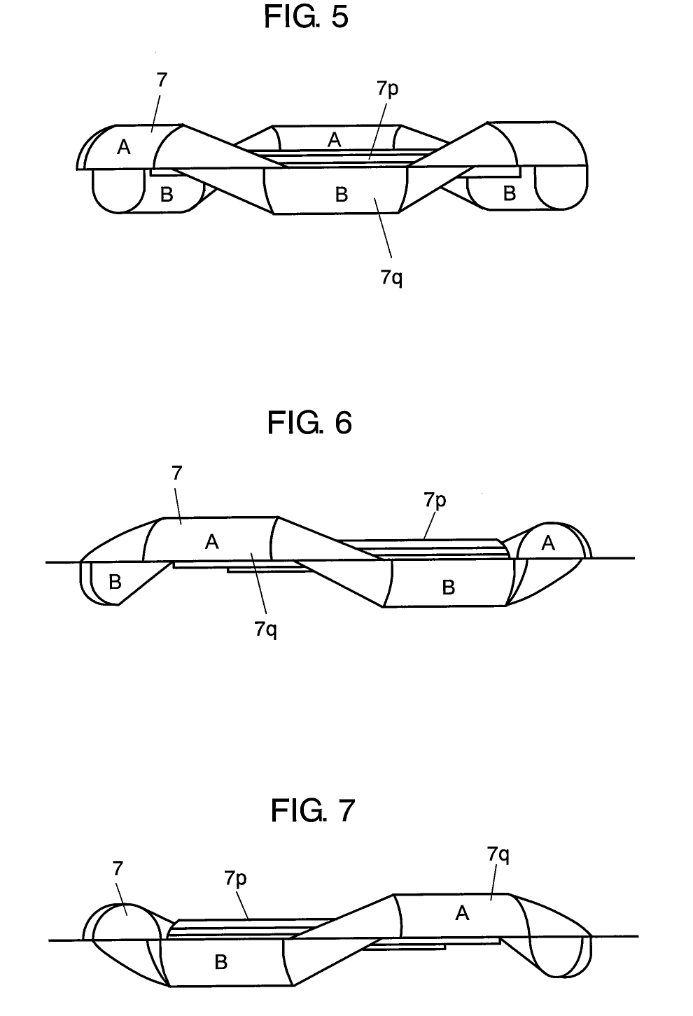

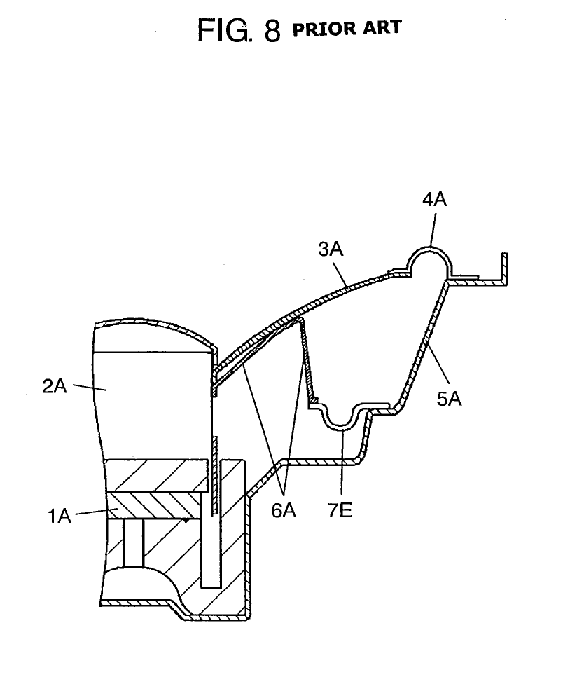

FIG. 3 is a perspective view of a key part of the loudspeaker in the second exemplary embodiment of the present invention. FIG. 4 is a plan view of a key part of the loudspeaker in the second exemplary embodiment of the present invention. FIG. 5 is a left side view of a key part of the loudspeaker in the second exemplary embodiment of the present invention. FIG. 6 is a front view of a key part of the loudspeaker in the second exemplary embodiment of the present invention. FIG. 7 is a rear view of a key part of the second exemplary embodiment of the present invention.

In FIGS. 3 to 7, ring edge 7q is configured such that it alternately protrudes upward and downward in a circumferential direction so that ring edge 7q can easily follow the movement of voice coil unit 2. In addition, ring edge 7q is resilient. If the audio signal is applied to voice coil 2b of voice coil unit 2, voice coil unit 2 reacts with the magnetic field in magnetic gap 8, and movers vertically. If an excursion of voice coil unit 2 is small, ring connector 7p does not impose a large load on the movement of voice coil unit 2. However, as the excursion of voice coil unit 2 becomes larger, this ring connector 7p hinders smooth vertical movement.

Accordingly, in the loudspeaker in the second exemplary embodiment, the outer rim of ring connector 7p is connected to frame 5 via ring edge 7q. When the excursion of voice coil unit 2 becomes large and ring connector 7p starts to apply load, stress is applied to ring edge 7q. Ring edge 7q then resiliently deforms in response to this stress. Accordingly, although the excursion of voice coil unit 2 rises, the presence of ring edge 7q prevents hindering of the excursion, and thus reduction of driving efficiency is suppressed. In the second exemplary embodiment, voice coil unit 2 is vertically supported by two supports: edge 4 and edge member 7 (combined part of ring connector 7p and ring edge 7q). To improve the driving efficiency of diaphragm 3, edge 4 is thinned so that its weight becomes lighter. This makes the weight of diaphragm 3 and edge 4 lighter, providing a structure that improves the driving efficiency of diaphragm 3. However, if edge 4 is thinned, the strength to support voice coil unit 2 is reduced. Therefore, ring edge 7q of edge member 7 is made thicker than edge 4 so as to prevent degradation in the strength to support voice coil unit 2. As a result, Young's modulus of edge member 7 (combined part of ring connector 7p and ring edge 7q) becomes greater (harder) than that of edge 4.

In the above structure, edge member 7 (combined part of ring connector 7p and ring edge 7q) dominantly supports voice coil unit 2. Accordingly, the upper load and lower load of edge member 7 need to be kept at the same level as much as possible to suppress distortion in the vertical movement of the diaphragm. Since ring connector 7p moves only slightly, as described above, a structure shown in FIGS. 3 to 7 is adopted in the second exemplary embodiment so as to keep the upper and lower loads of ring edge 7q at the same level.

Ring edge 7q is made of rubber or synthetic resin, and has upward and downward protrusions alternately in a circumferential direction on six equal circumferentially-segmented parts, as shown in FIGS. 3 to 7. As a result, three upward protrusions and three downward protrusions are provided in this structure.

These protrusions are further detailed next. In FIGS. 3 and 4, protrusion A protrudes upward, and protrusion B protrudes downward. Triangular protrusion a protrudes upward, next to protrusion A, and triangular protrusion b protrudes downward, next to protrusion B. These triangular protrusions a and b are extremely important components in order to avoid the formation of a vertical wall at a point where the protrusions change from protrusion A to protrusion B. As a whole, with this structure, upper and lower loads of ring edge 7q in the circumferential direction are kept at substantially the same level. A significant characteristic of the loudspeaker in the second exemplary embodiment of the present invention is that upper and lower loads of edge member 7 (combined part of ring connector 7p and ring edge 7q) that practically supports voice coil unit 2 are kept at the same level.

This characteristic achieves symmetric vertical excursion of diaphragm 3, reducing distortion of the loudspeaker. In addition, edge 4, which has a large area on the outer rim of diaphragm 3, is thinned to make it lighter. This achieves high driving efficiency, even in mid-range loudspeakers and tweeters.

### INDUSTRIAL APPLICABILITY

The loudspeaker of the present invention reduces distortion of the loudspeaker and improves its driving efficiency. In particular, the present invention is effectively applicable to mid-range loudspeakers and tweeters.

1. A loudspeaker comprising:
a frame;
a diaphragm whose outer rim is supported by the frame via an edge;
a voice coil unit connected to the diaphragm;
a magnetic circuit where a voice coil of the voice coil unit is movably disposed in its magnetic gap; and
a first edge member and a second edge member for supporting the voice coil unit by the frame, the voice coil unit being supported at two points at a predetermined interval to a side of a magnetic gap from a part where the diaphragm is connected; the first edge member and the second edge member respectively including:
a heat-resistant connector that allows air to pass through; and
a ring-shaped edge made of a resilient material, the edge being connected to the connector;
wherein
one of the edge of the first edge member and the edge of the second edge member protrudes toward the diaphragm, and an other edge protrudes toward the magnetic circuit.

2. A loudspeaker comprising:
a frame;
a diaphragm whose outer rim is supported by the frame;
a voice coil unit connected to the diaphragm;
a magnetic circuit where a voice coil of the voice coil unit is movably disposed in its magnetic gap; and
an edge member for supporting the voice coil unit by the frame, the voice coil unit being supported at a point to a side of a magnetic gap from a part where the diaphragm is connected; the edge member including:
a heat-resistant connector that allows air to pass through; and
a ring-shaped edge made of a resilient material, the edge being connected to the connector;
wherein
the edge alternately protrudes upward and downward in a circumferential direction.

3. The loudspeaker of claim 1,
wherein
the connector of the first edge member and the connector of the second edge member are ring-shaped, inner rims of the connector of the first edge member and the connector of the second edge member are connected to the voice coil, outer rims of the connector of the first edge member and the connector of the second edge member are connected to inner rims of the edge of the first edge member and the edge of the second edge member, respectively; and outer rims of the edge of the first edge member and the edge of the second edge member are connected to the frame.

4. The loudspeaker of claim 2, wherein the connector of the edge member is ring-shaped, an inner rim of the connector is connected to the voice coil, an outer rim of the connector is connected to the inner rim of the edge, and the outer rim of the edge is connected to the frame.

5. The loudspeaker of claim 1, wherein the connector of the first edge member and the connector of the second edge member are made of a material that allows air to pass through; and
the edge of the first edge member and the edge of the second edge member are made of one of a rubber material and a synthetic resin material.

6. The loudspeaker of claim 2, wherein the connector of the edge member is made of a material that allows air to pass through, and the edge of the edge member is made of one of a rubber material and a synthetic resin material.

7. The loudspeaker of claim 3,
wherein the connector of the first edge member and the connector of the second edge member are made of a material that allows air to pass through; and
the edge of the first edge member and the edge of the second edge member are made of one of a rubber material and a synthetic resin material.

8. The loudspeaker of claim 4,
wherein the connector of the edge member is made of a material that allows air to pass through, and the edge of the edge member is made of one of a rubber material and a synthetic resin material.
